(19) United States
(12) Patent Application Publication
(10) Pub. No.: US 2015/0262052 A1
(43) Pub. Date: Sep. 17, 2015

(54) OMNI SMART CARD

(71) Applicant: EBAY INC., San Jose, CA (US)

(72) Inventor: Anupam Pahuja, Singapore (SG)

(21) Appl. No.: 14/657,929

(22) Filed: Mar. 13, 2015

(30) Foreign Application Priority Data
Mar. 14, 2014 (IN) 315/KOL/2014

(51) Int. Cl. G06K 19/07; G06K 19/073; G06K 7/10; G06K 19/04

(52) U.S. Cl. CPC G06K 19/072; G06K 19/0719; G06K 19/044; G06K 19/073; G06K 19/045; G06K 7/10227

(57) ABSTRACT

In an embodiment, a method includes receiving, by an electronic processor of a smart card device, user inputs including unique user authentication information. Also, it includes storing transaction instrument information associated with transaction instrument(s). It also includes presenting transaction instrument information associated with each transaction instrument(s). The method also includes receiving a user input selecting a transaction instrument for use in connection with a transaction. It further includes determining the selected transaction instrument based at least in part on the user inputs. It also includes encoding the transaction instrument information associated with the transaction instrument selected by the user. And it includes providing the transaction instrument information associated with the selected transaction instrument for use in connection with the transaction. In various embodiments, the electronic processor may control a component, for example a programmable magnetic strip or EMV chip, for encoding, in real time, parameter(s) of a user-selected transaction instrument.

### RELATED APPLICATIONS

The present disclosure claims priority to and the benefit of provisional Indian patent application no. 315/KOL/2014 filed on Mar. 14, 2014, the contents of which are incorporated herein by reference in their entirety.

### BACKGROUND

1. Technical Field

Embodiments of the present disclosure generally relate to transaction instruments, and more particularly, to a smart device or smart card that may be used in transactions.

2. Related Art

Currently, transactions such as purchases, bidding, etc. may be conducted using various transaction instruments such as credit cards, gift cards, rewards cards, etc. or even a mobile device. For example, customers may use the various transaction instruments at both online and offline sellers, where they may use them to purchase items of their choosing. But while such transaction instruments may provide customers with some choice, they may still be inefficient and insecure in certain aspects. For example, customers may have to carry multiple transaction instruments such as multiple credit cards or be tethered to a mobile device. Also, such transaction instruments may be at risk of being lost, stolen or hacked.

### BRIEF DESCRIPTION OF THE FIGURES

FIG. 1 illustrates a front side of an omni or universal smart card showing various components of the omni or universal smart card according to an embodiment of the present disclosure.

FIG. 2 illustrates a back side of the omni or universal smart card according to an embodiment of the present disclosure.

FIG. 3 illustrates an internal view of an omni or universal smart card according to an embodiment of the present disclosure.

FIG. 4 illustrates a user device screen shot of an application for setting up an omni or universal smart card according to an embodiment of the present disclosure.

FIG. 5 is a flow diagram illustrating a method for using an omni or universal smart card according to an embodiment of the present disclosure.

FIG. 6 is a diagram illustrating an omni or universal smart card including a biometric interface according to another embodiment of the present disclosure.

FIG. 7 is a diagram illustrating a rechargeable omni or universal smart card according to another embodiment of the present disclosure.

FIG. 8 is a diagram illustrating a solar powered omni or universal smart card according to another embodiment of the present disclosure.

FIG. 9 is a flow diagram illustrating a method of encrypting transaction instruments using double randomization via a remote server according to an embodiment of the present disclosure.

FIG. 10 is a diagram illustrating a networked system suitable for implementing one or more embodiments of the present disclosure.

FIG. 11 is a block diagram of a computer system suitable for implementing one or more components in FIG. 10, according to an embodiment of the present disclosure.

Like element numbers in different figures represent the same or similar elements.

### DETAILED DESCRIPTION

According to one or more embodiments of the present disclosure, methods and systems provide a smart device (also referred to as “omni smart card” or “omni or universal smart card”) that is secure and overcomes inconveniences associated with typical transaction instruments. In one or more embodiments, an omni smart card may have the ability to store various transaction instruments in one device. As such, the omni smart card according to one or more embodiments may obviate the need for carrying multiple transaction instruments such as credit cards, gift cards, etc., or a mobile device for transactions. Also, an omni smart card according to various embodiments may be highly secure at least in part because it may use unique user identification information such as biometric authentication for each use of the omni smart card. Furthermore, information on the omni smart card may be encrypted on the device and during transmission. The omni smart card may also allow a user to disable and/or enable one or more funding sources or other information stored therein for a specific user or a specific use.

Transaction instruments that may be stored in an omni smart card according to one or more embodiments may include, for example, credit cards, debit cards, loyalty cards, gift cards, identity cards, membership cards, medical cards, insurance cards, driver's license information, payment provider information, other funding sources information, etc.

The omni smart card according to one or more embodiments may have a form factor similar to a transaction card, for example, it may be of a similar form or form factor as a credit card. In one embodiment, the omni smart card may work with a traditional magnetic strip reader or EMV reader that is typically used by various sellers at their point of sale locations. As such, the omni smart card may be easy to use and be carried without the need for a user to be tethered to a mobile device (e.g., a mobile phone, tablet, or the like), and it may work for a long period of time, e.g. approximately two years, on a single battery charge.

In an embodiment, an omni smart card may work with a chip and a unique identifier such as a PIN, a password, a passcode, etc. Also, the omni smart card may ride on credit card rails or have direct access to a payment provider via a network such as the Internet. The omni smart card may have the ability to check key metrics, for example, key payment provider metrics such as checking the current balance of an account, or checking the last few transactions conducted.

An omni smart card according to an embodiment may also allow a user to disable and/or enable one or more funding sources or other information stored therein for a specific user and/or a specific use. For example, funding sources or other information such as driver's license information, gym membership information, medical card information, etc. may be enabled or disabled for a specific user. For instance, a child may only be allowed to use certain funding sources on a parent's omni smart card. Or in another example, only specific information stored in the omni smart card may be enabled or disabled for a specific use, for example, only gym membership information may be allowed to be communicated to a system at the gym, but not other information stored in the omni smart card.

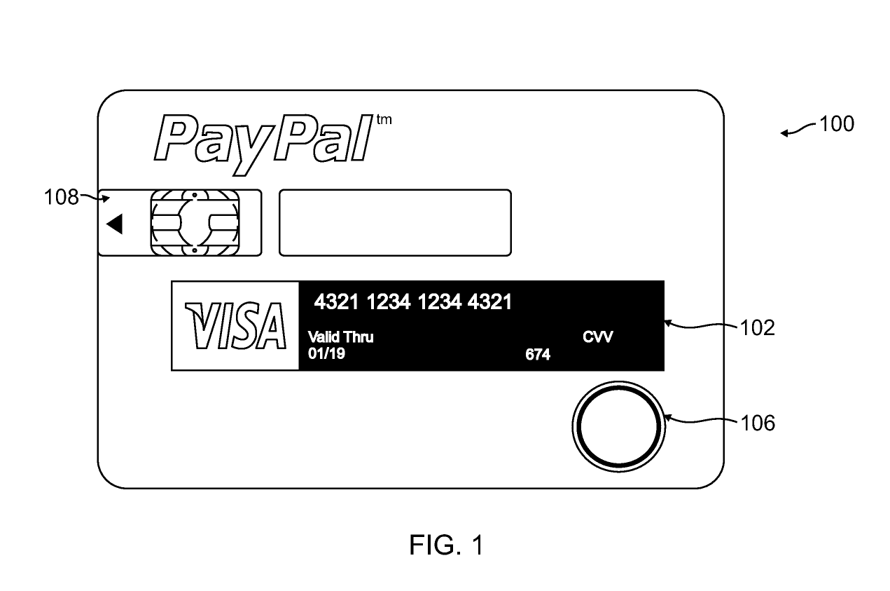

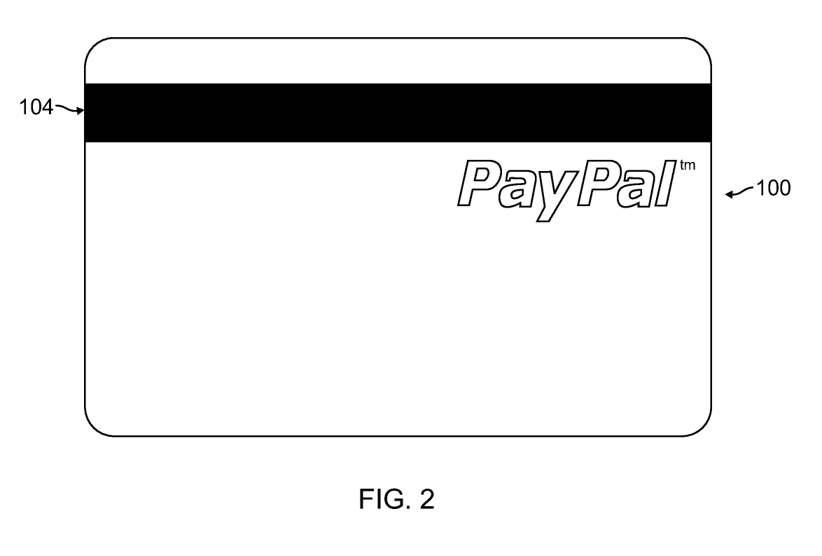

Referring now to the drawings wherein the showings are for purposes of illustrating embodiments of the present disclosure only, and not for purposes of limiting the same, FIGS. 1 and 2 are diagrams illustrating a front view and a back view, respectively, of an omni or universal smart card according to an embodiment of the present disclosure.

As illustrated in the embodiments of FIGS. 1 and 2, an omni or universal smart card 100 may have the general form of a transaction card such as a credit card. FIG. 1 illustrates a front side that includes various components of the omni smart card 100. The components include a display area 102, a user interface 106, and a programmable chip 108, e.g., a programmable EMV, on the front side of the omni smart card 100. It should be appreciated that although omni smart card 100 is illustrated as having the general form of a transaction card such as a credit card, an omni smart card may have any appropriate shape, design, form, color, size, etc. and may have additional components as appropriate.

In various embodiments, display area 102 may include an OLED screen, an E-Ink screen, a flexible OTFT-LCD (organic thin film transistor-liquid crystal display), an electrophoretic display, a plasma display, or the like.

Omni smart card 100 may dynamically generate information that may be displayed on display area 102. For example, information may be dynamically generated such as funding source information including, for instance, a credit card number or a payment provider account code (e.g. a PayPal® code) for each transaction at the time of a transaction. In this embodiment, display area 102 shows information associated with a VISA® account including a VISA® card number (“4321 1234 1234 4321”), validity dates (e.g. “Valid Thru 01/19”), a CVV code, etc. It should be appreciated that any other pertinent information may be displayed on display area 102 as appropriate. Also, it should be appreciated that although the omni smart card 100 illustrated in the embodiment of FIG. 1 shows that it may be implemented or provided by PayPal®, the omni smart card may be implemented or provided by any appropriate financial institution, service provider or entity. Conveniently, the displayed transaction card information may be provided to an entity, seller or merchant in connection with a transaction for example, credit card information may be provided for payment to a seller either at a physical point of sale location, or during an online transaction.

In various embodiments, display area 102 may present a user's information or may present aliased information such as a random number as a transaction card number, for example, a random credit card number. The display area 102 may display a funding source selected by the user, or it may present the user's name. The display area 102 may present information traditionally printed on a transaction card such as a credit card or any other appropriate card that may be stored therein. Or it may display a photo of the user. As such, display area 102 of the omni smart card may present various types of information such as transaction card information, personal information, photos, an account balance, offers, credit options, a virtual account number, available funds, information about previous transactions, etc. In an embodiment, information, for example information associated with each of one or more transaction instruments may be encoded based on a timing signal, wherein the information associated with the transaction instrument(s) may be changed at least every 30 seconds, every 60 seconds, every 120 second, etc.

User interface 106 may include a mechanism for receiving unique owner or user identification information, for example, user interface 106 may include a biometric sensor such as a fingerprint reader, a retina scanner, etc. User interface 106 may also include a touch interface such as a touch sensor or button configured as a toggle button, for example, that may be held and pressed to view various transaction instruments stored in omni card 100, and let go when a desired transaction instrument is displayed.

In that regard, the information generated by the omni smart card such as a transaction card number may be associated with unique user identification or authentication information such as biometric information of an owner or user and his or her account information that is stored by a transaction card issuer or other appropriate entity. In an embodiment, biometric information may be entered or inputted via interface 106. For example, a biometric sensor may operate as follows: i) a user may use a thumbprint to access a desired funding source such as a credit card; ii) the user presses and holds the interface 106 to switch through funding sources as may be displayed on display area 102; and iii) the user may lift pressure to select a funding source. An interface such as a button may be used to hold and display transaction instruments over time.

In an embodiment, biometric authentication may be performed for each use or each transaction. As such, a lost or stolen card cannot be used fraudulently as a result of an unsuccessful biometric authentication. In an embodiment, stored information or data may be erased after a pre-set number of unsuccessful biometric attempts, for example, after 3, 5, 7, etc. unsuccessful biometric attempts.

In an embodiment, duration or card time-outs may be activated such that the omni smart card may become inactive after a set period of time, for example, the omni smart card may time out after “n” seconds. In that regard, a display showing transaction card information may time out and erase the information after a pre-set number of seconds, for example, after 10, 20, 30 seconds, etc. As such, the data or information of the omni smart card may be protected.

Also, for improved security, communications between a user device associated with a user such as a mobile phone and an omni smart card may be encrypted, for example, communications when setting up the omni smart card (as will be described in more detail below) may be encrypted. For instance, Bluetooth synchronization between a mobile device and the omni smart card may be encrypted. Transaction instrument data such as credit card numbers or other data as well as biometric data such as fingerprint data may also be encrypted.

Advantageously, a high level of security is provided due at least in part to a combination of uniquely identifying each owner or user and each transaction with frictionless non user intervention.

FIG. 2 illustrates a back side of the omni or universal smart card 100. The back side of omni smart card 100 may include a magnetic strip 104, which may be programmable to include information associated with one or more accounts related to various funding sources or transaction instruments, for example, information associated with a VISA account or any other appropriate transaction instrument. In this regard, the omni smart card 100 may work with a traditional magnetic strip reader that is typically used by various sellers at their point of sale locations. In various embodiments a solenoid may be included. Magnetic strip 104 may be programmable such that the following features may be provided:

i. User selection—The user may select the information to be programmed into the magnetic strip 104. For example, the user may select one or more transaction instruments and associated data to be programmed on to omni smart card 100. In an embodiment, user selections may be communicated to a remote location, for example a card issuer or server via a website, or any other appropriate communication means such as email, text, telephone communication, in-person, etc.

ii. In general, magnetic strip 104 may include 3 tracks. Track 3 of magnetic strip 104 may provide, for example, payment provider information such as PayPal® information. In an embodiment, a Track 1 and a Track 2 of magnetic strip 104 may be used for certain transaction instrument information such as loyalty card information or credit card information, respectively. Track 3 information may also include user contact information such as email address, phone number, etc. Each track may include information as appropriate.

iii. Control. Magnetic strip 104 may allow setting controls for the omni smart card and vice versa, the omni smart card may allow setting controls for magnetic strip 104. The controls may be set by an owner or user of the card, or by an entity or issuer of the card, for example. In various embodiments, controls may include: 1) Power off, for example, the omni smart card may turn off automatically, for instance, after a pre-set time such as after 12, 14, 16 hours of the omni smart being turned on or activated, or at midnight every night, etc.; 2. On/off power when a reader is detected, for example, the omni smart card may be turned off if there is no reader detected in a surrounding area, and may be turned on upon detection of a reader, for instance, at a point of sale location; 3. On/off power by user action, for example, a user may use an interface such as a push button to turn the omni smart card on or off as desired, 4. On/off power by location, etc., for example, the omni smart card may automatically turn on in predetermined locations such as a store, a gym, a coffee shop, etc. As such, one or more settings may be set for the omni smart card including restricting certain transaction instruments for use by a specified user (e.g., a child may only use one transaction instrument), or certain transaction information for a specified use (e.g., only gym card information may be shown or transmitted at a gym location or system).

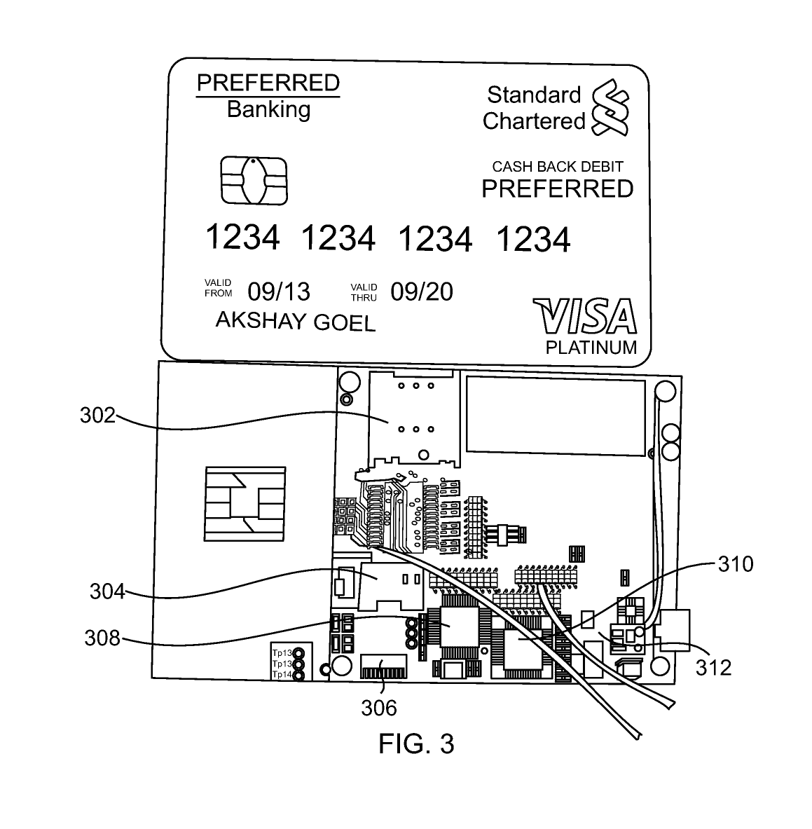

Referring now to FIG. 3, a diagram illustrates an internal view of an omni or universal smart card according to an embodiment of the present disclosure.

An omni smart card according to one or more embodiments may include various internal components including a chip 302 such as an EMV chip, a communications module 304 for Bluetooth communications or other near communications, a display connector 306, for example an OLED connector, a chip controller 308 such as an EMV controller, a micro controller 310, and a battery manager 312. Notably, a battery may be sized according to the potential use, for example, the potential yearly use. For instance, the battery may be sized for 4 times the average yearly use based on the number of transaction instruments such as credit cards stored in the omni smart card, the number of swipes per year, the number of times a new transaction instrument such as a credit card is uploaded to a device in a year, etc.

Chip 302 such as an EMV chip or other appropriate integrated circuit, may store data or information including information about a transaction instrument such as a user's account, including, for example:

i. Encryption keys, ii. Virtual money information such as bitcoin tracked information, iii. User specific information such as contact information including email, phone number, etc., iv. Authentication information such as a photo for 3-factor identification, wherein the photo may be sent to an entity to verify the identification, v. Geo-location information, vi. Additional security mechanisms, vii. Storage of transaction data to enable returns, loyalty or store credit, and/or any other appropriate data or information.

In various embodiments, microcontroller 310 of the omni smart card may be configured to control a programmable magnetic strip, e.g., magnetic strip 104 illustrated in the embodiment of FIG. 2, to allow real-time or on-the-fly encoding of transaction instrument information including one or more parameters (e.g., account name, account number, etc.) associated with a transaction instrument chosen by a user, for example, a transaction instrument chosen for use in connection with one or more transactions such as making purchases. In other embodiments, microcontroller 310 or chip controller 308 of the omni smart card may be configured to control a programmable chip such as chip 302 to allow real-time or on-the-fly encoding of transaction instrument information including one or more parameters (e.g., account name, account number, etc.) associated with a transaction instrument chosen by a user, for example, for use in connection with one or more transactions such as making purchases.

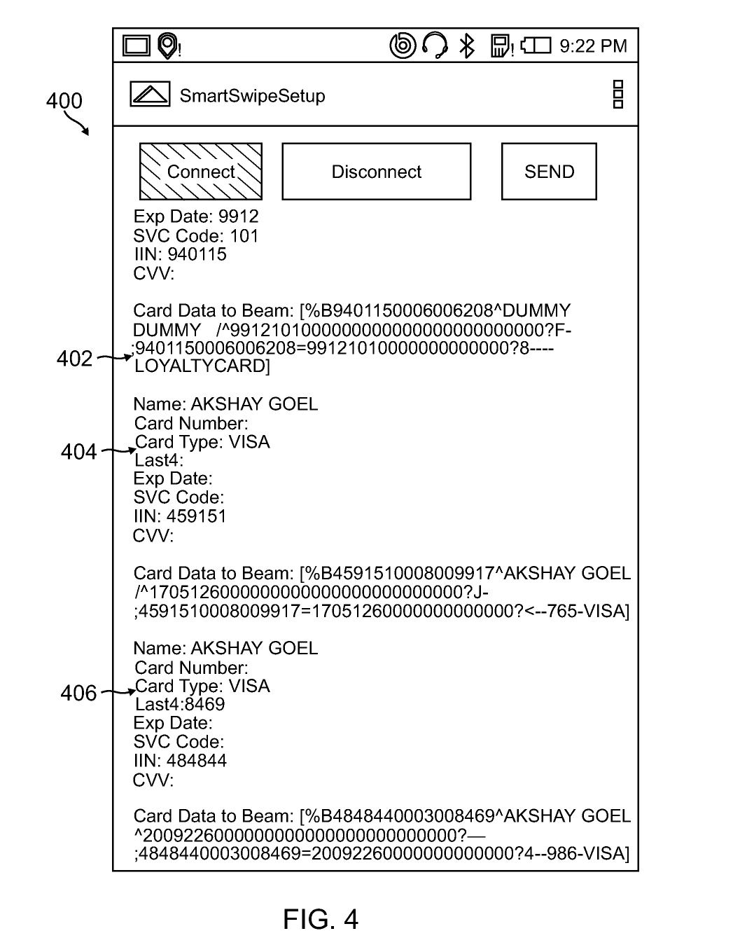

Referring to FIG. 4, a user device screen shot of an application for setting up an omni or universal smart card is illustrated according to an embodiment of the present disclosure. In the embodiment of FIG. 4, a user device 400 (e.g., a mobile device, a tablet, a laptop, etc.) may be used to load an application that enables the user to transmit information for setting up an omni smart card. Information related to one or more transaction instruments may be captured. The transaction instrument information may be captured from each transaction instrument, for example, through a service provider dongle (e.g. PayPal® dongle) or by using any other appropriate connection hardware. In another example, information related to a transaction instrument may be captured via an image capturing device of the user device (e.g., phone camera), or via any other appropriate interfaces of the user device (e.g., a sensor, RFID, NFC, IR, scanner, a custom reader, etc.). In another embodiment, transaction instrument information may be captured by swiping the transaction instruments on a service provided by a payment provider such as PayPal Here® into a digital wallet such as PayPal Wallet®.

For instance, at 402, information about a loyalty card may be captured. At 404, information about a transaction card may be captured, for instance, the captured information may include a transaction instrument type or name such as a card type or name (e.g., VISA), a card number, an expiration date, a code, etc. At 406, information about another transaction may be captured, for instance the captured information may include a card type or name (e.g., VISA), a card number, an expiration date, a code, etc.

In various embodiments, the information related to one or more transaction instruments may include any type of information including not only information related to a transaction card, but also payment provider IDs, passwords, and any other type of transaction instrument information. It should be appreciated that virtually an unlimited number of transaction instruments may be captured using user device 400 for subsequent transmission, storage and set up of a smart omni card.

Once captured by user device 400, the information related to the one or more transaction instruments may be encrypted and transmitted via an appropriate communications protocol such as Bluetooth to the omni smart card. In an embodiment, the information may be securely stored on the omni smart card, for example on all 3 tracks of a magnetic strip of the omni smart card. As noted above, virtually an unlimited number of transaction instruments, e.g., cards, may be stored by the omni smart card.

Advantageously, customers may only need one device, i.e., one omni smart card, to conduct transactions instead of having to carry multiple cards or a mobile device. Once the information related to one or more transaction instruments has been received by the omni smart card, the user device (e.g., mobile device) may not be needed for conducting a transaction. That is, one device, i.e., an omni smart card, may provide the option to use any or all cards, for example, a credit card, a debit card, a loyalty card, a gift card, a membership card, payment provider information, etc. Also, the omni smart card may provide the ability to use a payment provider balance offline, for example the omni smart card may use payment provider information stored therein, for example, PayPal® account information, to conduct transactions without having to log into the user's payment provider account. Furthermore, the omni smart card may be highly secure at least in part because of its capability for frictionless authentication such as biometric authentication, which may reduce the risk of card theft and other security risks.

Entities such as sellers or merchants may benefit from the use of omni smart cards as well. For example, merchants may not need additional equipment at their point of sale locations. In that regard, omni smart cards may be compatible with existing magnetic readers typically used at sellers' locations. In an embodiment, merchants may get paid via a payment provider balance, which may require lower fees, for example, merchants may get paid through PayPal® balance using PayPal Here®. Furthermore, merchants may benefit from reduced chargeback overheads due at least in part to the enhanced security features of omni smart cards as discussed above according to one or more embodiments. Payment providers or other institutions or entities such as PayPal® may benefit from a potential increase of consumers adopting of the payment provider services such as PayPal® or PayPal Here®.

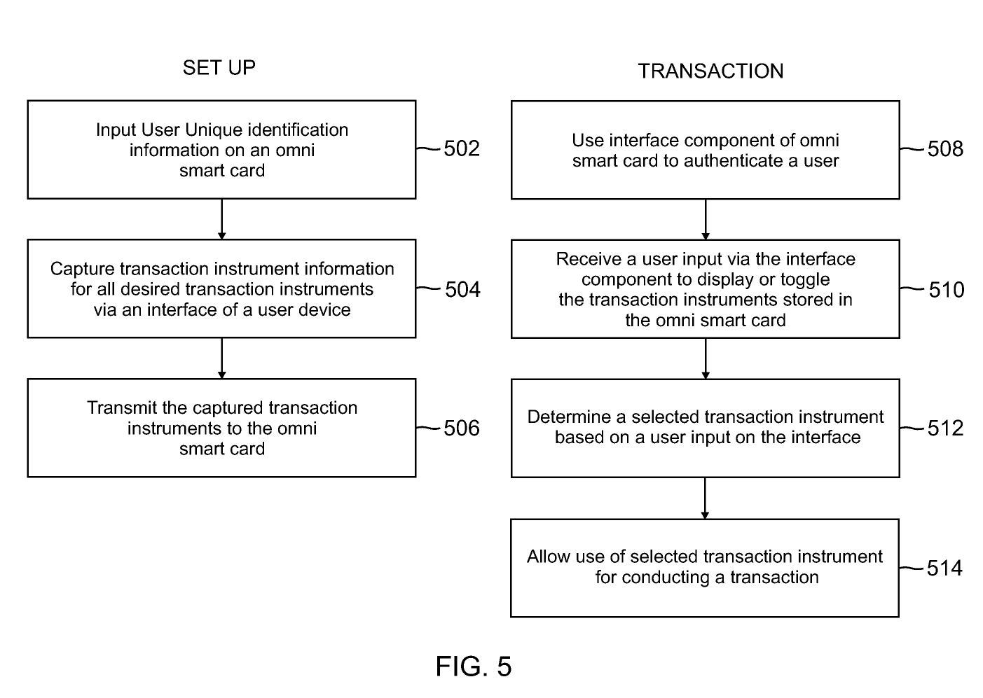

Referring now to FIG. 5, a flow chart illustrates a method for using an omni or universal smart card according to an embodiment of the present disclosure. In one or more embodiments, a user may first set up his or her omni smart card before conducting a transaction with the omni smart card.

For setting up an omni smart card, in block 502, a user may input, and an omni smart card may receive, the user's unique identification information such as biometric information, for example, a user may record his or her fingerprint on the omni smart card.

In block 504, the user may capture transaction instrument information associated with all the desired transaction instruments such as credit cards, debit cards, etc., via an interface of a user device, for example, the user may capture all of his or her transaction cards via a payment provider dongle, or via a camera, or by swiping the cards on a service such as PayPal Here® into a digital wallet such as PayPal Wallet®.

In block 506, the captured information associated with the transaction instruments may be beamed or transmitted to the omni smart card. For example, information associated with the captured transaction instruments including payment provider account details, etc. may be transmitted to the omni smart card over an appropriate communications protocol such as Bluetooth. Such transmission may be encrypted for enhanced security.

After the omni smart card has been set up, a transaction may be conducted using the omni smart card. It should be noted that appropriate settings may be set up by the user or by an application provider as desired, for example, settings for powering on or off of the omni smart card depending on time, surroundings, environment, locations, etc., amount of time for displaying information on a display of the omni smart card, transaction instruments allowed for use by certain users, transaction information allowed in interactions related to certain uses, etc. In block 508, an interface component of the omni smart card (for example, interface 106 illustrated in the embodiment of FIG. 1) may be used to authenticate a user. In an example, interface 106 of an omni smart card may include a fingerprint sensor. As such, a user may be authenticated without there being any need to carry or be tethered to a user device such as a mobile device.

In block 510, a user input is received via the interface component (e.g., by pressing a button) of the omni smart card in order to display or toggle the transaction instruments stored in the omni smart card. For example, a user may continue to keep his or her finger on the fingerprint sensor to toggle through all the cards stored in the omni smart card.

In block 512, a selected transaction instrument is determined based on the user input on the interface. For example, the user may select a displayed transaction instrument by removing his or her finger from the fingerprint sensor.

In various embodiments, the user may make an account selection, that is, the user may select from multiple accounts, including for example: i. A funding source such as VISA, American Express®, PayPal®, etc., ii. Loyalty card, etc., iii. Identification or ID such as a driver's license, a gym or YMCA card, a corporate card, etc. In an embodiment, the user may split a transaction over multiple cards on the omni smart card to make a divided payment.

In block 514, the selected transaction instrument in the omni smart card may be used in connection with a transaction. In various embodiments, the transaction may be an e-commerce transaction or a transaction at a physical POS location. For example, for an e-commerce transaction, once the user has selected a transaction instrument, e.g., a funding source such as a credit card or other account or information, which may be displayed for example on a screen 102 of the omni smart card illustrated in the embodiment of FIG. 1, the user may use the selected transaction instrument information to conduct an online transaction, for example, the user may input the transaction instrument information (e.g., account number, expiration date, etc.) into a website or shopping cart provided by an online entity. For a transaction at a physical POS location, the user may provide the omni smart card displaying the selected transaction instrument to an entity such as a seller or merchant in connection with a transaction. The entity such as a seller or merchant may then enter the information provided on the omni smart card on a POS device, or may swipe a magnetic strip (e.g., magnetic strip 104 illustrated in the embodiment of FIG. 2) of the omni smart card through a magnetic strip card reader located at the seller's location. Or alternatively, the merchant or seller may use the omni smart card for a chip-and-PIN transaction.

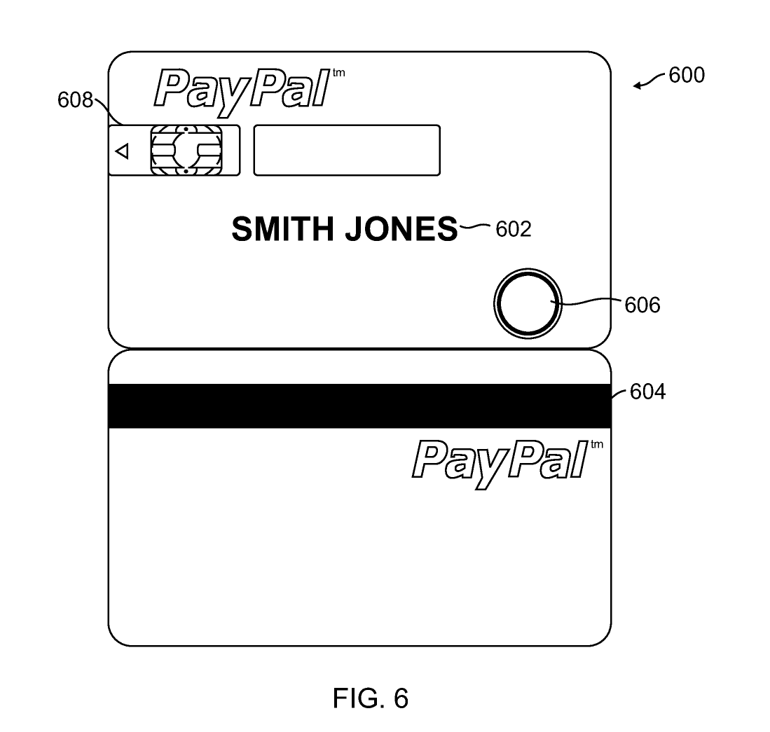

Referring now to FIG. 6, a diagram illustrates an omni or universal smart card including a biometric interface according to another embodiment of the present disclosure. In the embodiment of FIG. 6, an omni smart card 600 includes embossed data or information 602 on a front side of omni smart card 600, but may not include a display or a screen. In this example, a name may be embossed or engraved thereon, for example, the name “Smith Jones”. Omni smart card 600 may also include an interface 606 that includes a user input interface adapted to receive user inputs such as a biometric interface and a button similar to interface 106 described above with respect to the embodiment of FIG. 1. Omni smart card 600 may also include a chip 608 such as an EMV chip as described above according to one or more embodiments. A back side of omni smart card 600 may include a magnetic strip 604 similar to magnetic strip 104 described above with respect to the embodiment of FIG. 2.

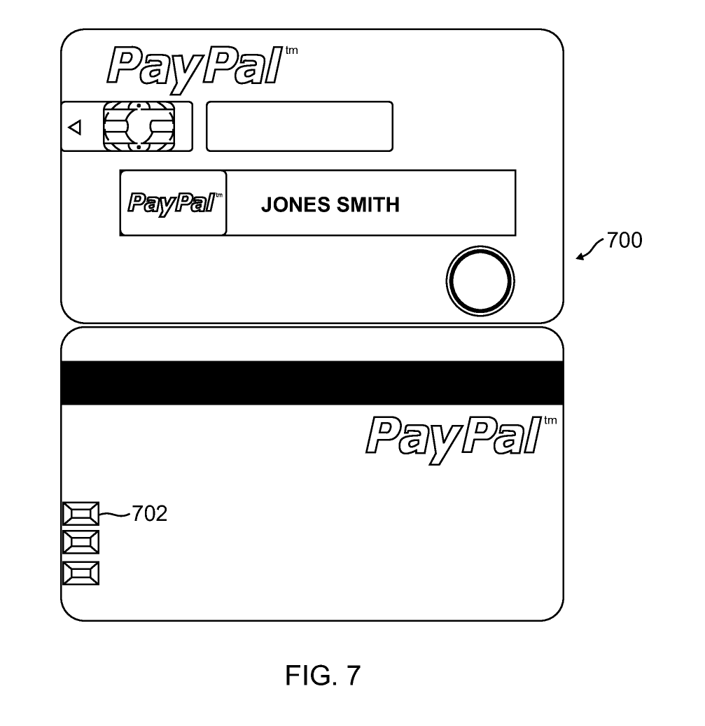

Referring now to FIG. 7, a diagram illustrates a rechargeable omni or universal smart card according to another embodiment of the present disclosure. In the embodiment of FIG. 7, an omni smart card 700 may have similar features or components as, for example, omni smart card 100 illustrated in the embodiment of FIGS. 1 and 2, and may also include charging contacts 702. Charging contacts 702 may enable omni smart card 700 to be charged as needed. Charging contacts 702 may be located on a back side of omni smart card 700. In other embodiments, charging contacts 702 may be located on a front side, or at any other suitable location or area of omni smart card 700.

In an embodiment, omni smart card 700 may be charged through induction or inductive coupling (for example, wireless charging). In that regard, a base or charging station may be used. The base or charging station may include coils capable of being coupled to a coil that may also be included in the omni smart card. Energy may be sent through the inducting coupling to the omni smart card, which may then use the energy to charge batteries or run the omni smart card.

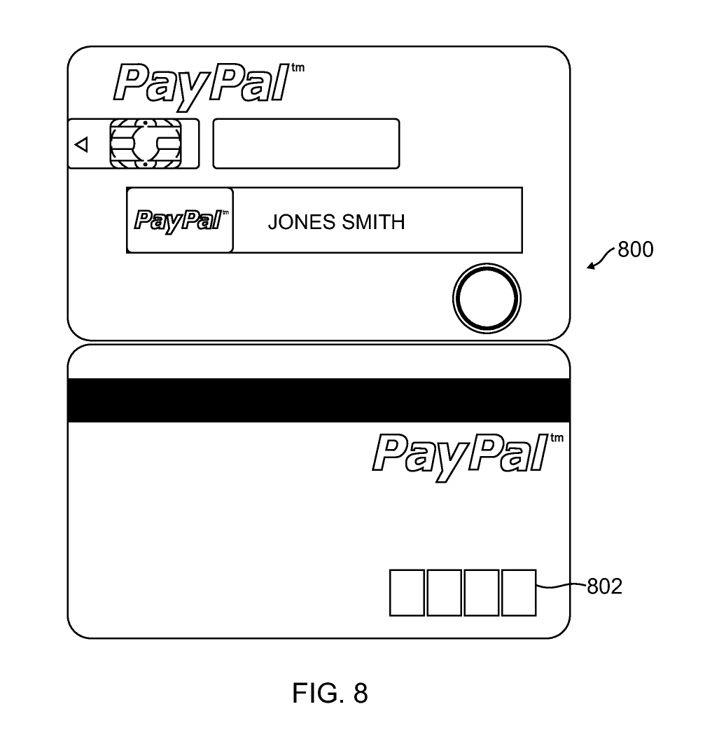

Referring now to FIG. 8, a diagram illustrates a solar powered omni or universal smart card according to another embodiment of the present disclosure. In the embodiment of FIG. 8, an omni smart card 800 may have similar features or components as, for example, omni smart card 100 illustrated in the embodiment of FIGS. 1 and 2, and solar cells 802 such that the omni smart card may be solar powered. Solar cells 802 may be located on a back side of the omni smart card. In other embodiments, solar cells 802 may be located on a front side, or at any other suitable location or area of omni smart card 800.

It should be appreciated that there may be many alternate options or features for the omni smart card. For example, the options illustrated in the embodiments of FIGS. 6-8 may be interchangeably combined with different components on a front side or a back side of the omni smart card. For example, a solar powered omni smart card may include solar cells on the back side and an OLED screen on the front side, or just embossed data and a biometric interface on the front side, etc.

As described in one or more embodiments above, an omni smart card may be rechargeable by solar power, wired power, induction, etc. The features or components of omni smart cards described above are not meant to be limiting and it should be appreciated that many more features may be implemented by an omni smart card. Other features of the omni smart card may include, for example: a) it may be remotely disabled, or data or information may be changed, for example, via a user device, b) Beacon—information may be transmitted, for example, in an encrypted manner, which may complement authentication, etc., c) Wireless—may display information from any wireless source, d) Parental notifications may be provided, e) Remote control of the device may be enabled, for example, via a user device, f) Scanning may be enabled using, for example, Red Laser, or other scanners or readers, which may enable storing of product information on the omni smart card, g) Bumping omni smart card devices with each other may enable further capabilities such as transfer of money, funds or other information between two or more omni smart card devices.

According to one or more embodiments of the present disclosure, a multi-user option may be provided. That is, one funding source may be used across multiple cards for multiple users. For example, a parent's VISA card may be used by a child as well. In that regard, the omni smart card may be set up to recognize multiple users' biometric data, for example.

In various embodiments, transactions may be conducted using the omni smart card wherein the use may be controlled or be subject to one or more restrictions. For example, an owner of an omni smart card may control the use of the omni smart card depending on various factors such as who is using the omni smart card. For example, the owner may give or lend the omni smart card to his son; however, use by the son may be restricted such that the use is limited to certain times, seller locations, items, etc.

Embodiments of the omni smart card may allow a user to disable and/or enable one or more funding sources or other information, for example, driver's license information, gym membership information, medical card information, etc. for a specific user. For instance, a child may only be allowed to use certain funding sources on the omni smart card. In another instance, gym membership information may only be allowed to be communicated to a system at the gym, but no other information stored in the omni smart card may be allowed to be communicated. That is, the owner may give or lend the omni smart card to another person to conduct transactions such as making a payment pursuant to the controls set by the original owner of the omni smart card.

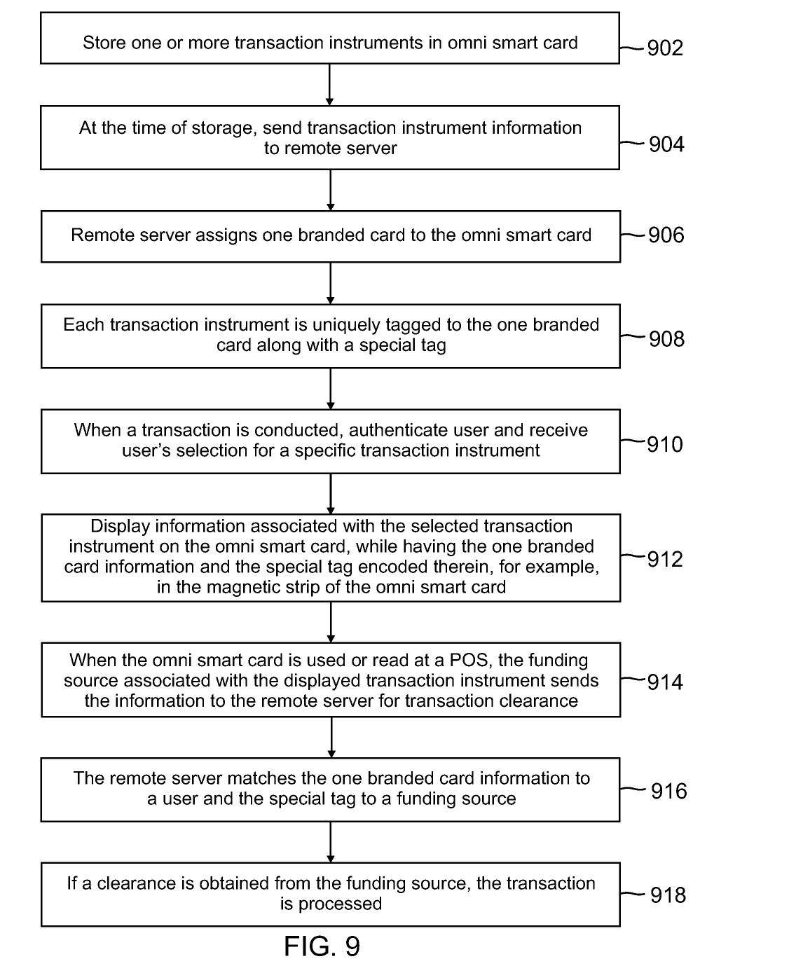

Referring now to FIG. 9, a flow diagram illustrates a method of encrypting transaction instruments using double randomization via a remote server according to an embodiment of the present disclosure.

According to one or more embodiments, transaction instruments such as transaction cards may be encrypted by double randomization such that an extremely secure way is provided for users or customers to conduct transactions using an omni smart card.

In block 902, a user may store one or more transaction instruments in an omni smart card. In an embodiment, a user may store transaction cards in an omni smart card by using the set up described above in connection with the embodiment of FIG. 5. For example, a user may store his or her transaction cards in an omni smart card, for instance, the user may store a Mileage Plus Visa™, a Chase Visa™, a Citi Mastercard™, etc.

In block 904, at the time of storage, information related to the transaction instruments may be sent to a remote server. For example, in response to the storage of the transaction cards on the omni smart card, the omni smart card may send this data or information to a service provider backend database. In one embodiment, the remote server may be implemented by a payment service provider such as PayPal®, Inc. or Ebay®, Inc. of San Jose, Calif., USA.

In block 906, the remote server may assign one branded card to the omni smart card. For example, where the remote server is implemented by PayPal®, PayPal® may assign one PayPal® branded transaction card to the omni smart card.

In block 908, each transaction instrument may be uniquely tagged to the one branded card along with a special tag. That is, each transaction card of the user may be uniquely tagged in the backend to the remote server branded card along with a special tag. For example, a Chase Visa® may be assigned to a unique remote server branded card (e.g., a unique PayPal® branded card) along with a Tag 1. A Mileage Plus Visa® may be assigned to the unique remote server branded card along with a Tag 2, and so on for all the transaction cards stored by the user.

In block 912, when a transaction is conducted, the user may be authenticated and a user's selection may be received for a specific transaction instrument to be used in connection with the transaction. For example, at the time of a purchase, a user may authenticate himself, e.g., by biometrics, a pin or password, etc., and may select to use a credit card from the omni smart card to make the purchase. In an example, the user may select to use his Mileage Plus Visa®.

In block 914, the omni card may display information associated with the selected transaction instrument while having the one branded card information and the special tag encoded therein, for example, in the magnetic strip of the omni smart card. In an example, a screen on the front side of the omni smart card may show the image of the selected funding source such as a transaction card, e.g., Mileage Plus Visa®, and the last 4 digits of the card, but, instead of the selected transaction card, e.g., Mileage Plus Visa®, the magnetic strip of the omni smart card may be encoded with the unique remote server branded card (e.g., the unique PayPal® branded card) and the associated special tag, e.g., Tag 2.

In block 916, when the omni smart card is used or read at a POS, the funding source associated with the displayed transaction instrument sends the information to the remote server for transaction clearance. For instance, when the omni smart card is swiped or read at a POS terminal, the funding source sends the information to the remote server for payment clearance because the swiped or read card is that of the remote server branded card.

In block 918, the remote server matches the one branded card information to a user and the special tag to a funding source. For example, the remote server, e.g., PayPal®, may match the PayPal® branded card numbers to a user, and recognizes that the tag on the card is Tag 2, therefore, PayPal® may contact, e.g., makes a call, to the funding source, e.g., Mileage Plus Visa®, for clearance. At this point, this may be similar to processes where a transaction is conducted using a payment provider such as PayPal® where the funding source is Mileage Plus Visa®.

In block 920, if clearance is obtained from the funding source, the transaction is processed. For example, if the funding source provides clearance, the user's funding source, e.g., Mileage Plus Visa®, is charged for an appropriate amount, and an appropriate message may be sent to the POS terminal.

Advantageously, systems and methods according to one or more embodiments may provide an extremely secure and frictionless transaction mechanism. The remote server, e.g., PayPal® is not pervasive. For instance, the remote server may be used via network connections such as Internet connections. The POS terminal manufacturers are not required to modify their equipment (i.e., the systems and methods described above provide an omni smart card that is compatible with POS devices or terminals). Also, systems and methods described above alleviate the inherent insecurity of using typical credit cards for conducting transactions, thus addressing customers' diminishing faith in such credit card transactions.

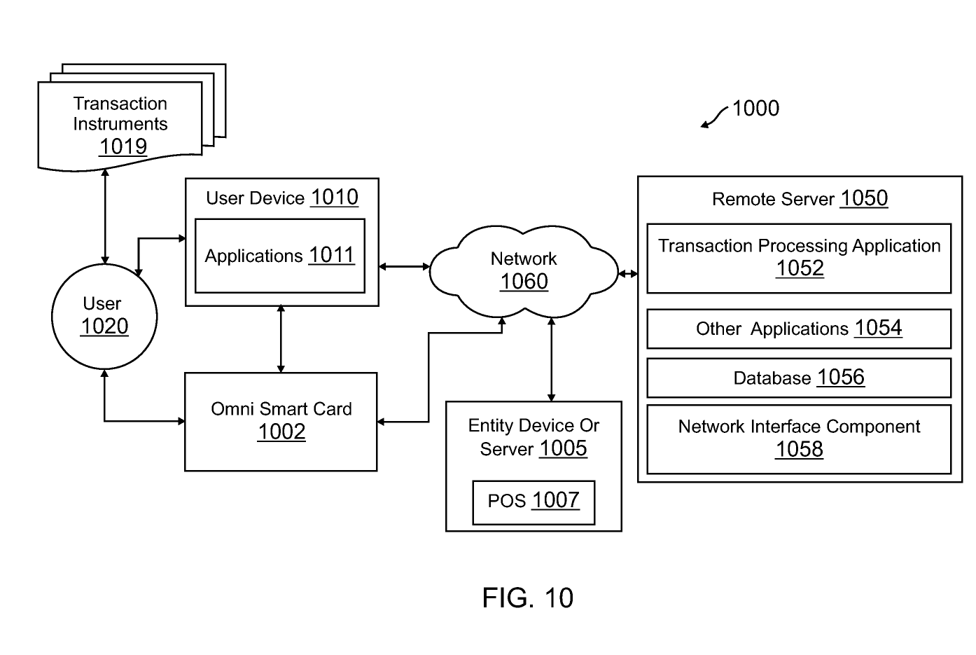

FIG. 10 is a diagram illustrating a networked system suitable for implementing one or more embodiments of the present disclosure. As shown, system 1000 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 10 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 1000 includes a user 1020, transaction instruments 1019 associated with user 1020, a user device 1010, an omni smart card 1002, an entity device or server 1005 and a remote server 1050 in communication over a network 1060. User 1020 may utilize user device 1010 and/or omni smart card 1002 to engage in transactions such as payment transfers with entity device or server 1005 through user device 1010 or omni smart card 1002. User 1020 may utilize remote server 1050, e.g., a payment provider server to complete the transaction such as payment transfers between the user 1020 and entity device or server 1005.

User device 1020, omni smart card 1002, entity device or server 1005, and remote server 1050 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 1000, and/or accessible over network 1060.

User device 1010, omni smart card 1002, and entity device or server 1005 may be implemented using any appropriate hardware and software configured for wired and/or wireless communication between user device 1010, omni smart card 1002, entity device or server 1005, and/or remote server 1050. For example, in one embodiment, user device 1010 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. As described above according to one or more embodiments, omni smart card 1002 may be implemented, for example, in the form of a transaction card capable of transmitting and/or receiving data over various communication protocols. Entity Device or Server 1005 may include a POS 1007 in the form of a device or terminal, for example, located at a physical location of an entity associated with entity device or server 1005. In another embodiment, POS 1007 may be implemented online, for example, via a website of an entity associated with entity device or server 1005. Although a user device, an omni smart card and an entity device or server are shown, the user device, the omni smart card and the entity device or server may be managed or controlled by any suitable processing device. Although only one user device, one omni smart card and one entity device or server are shown interacting, one or a plurality of user devices, omni smart cards and entity devices or servers may function similarly.

User device 1010 may include applications 1011. User device 1010 may be configured to download, install, and/or run various applications as may be desired in particular embodiments to provide desired features to user device 1010. For example, in various embodiments, applications 1011 may include security applications for implementing client-side security features, programmatic client applications for interfacing with appropriate application programming interfaces (APIs) over a network, or other types of applications.

Applications 1011 may correspond to processes, procedures, and/or applications, for example, a software program, executable by a hardware processor. In other embodiments, user device 1011 may include additional or different software as required.

In an embodiment, applications 1011 may include an application for capturing information from transaction instruments 1019. As described above according to one or more embodiments, user device 1010 may capture data or information from transaction instruments 1019 (e.g., transaction cards such as a credit card, a debit card, a driver's license, etc. or a remote server account) via an input device such as a camera, a dongle, or by user input via a keyboard, a touch pad, a scanner, a reader, etc. The captured transaction instrument information or data may then be communicated to omni smart card 1002 to be stored therein. Thus, applications 1011 provides an interface to capture, view, use and transmit captured data or information to omni smart card 1002. Such captured data or information may be presentable to user 1020 through an output device of user device 1010, such as a display module. As described above according to one or more embodiments, the captured data or information may also be displayed though an output device of omni smart card 1002, which may store the data or information to a non-transitory memory of omni smart card 1002 in the form of for example, card name issuer, account number, expiration date, code, address, phone number, email address, user account names, or other information. In various embodiments, the data or information may have identifying information for a payment account with remote server 1050 such as a payment provider server. In other embodiments, data or information may include financial information (e.g., a financial account, payment card, etc.) corresponding to user 1020 to enable user 1020 to identify a financial account with a financial provider, such as a bank, used for monetary transfers, and vice versa.

Applications 1011 may receive payment account/financial information through user input using an input device of user device 1020. Thus, 1011 may utilize a communication module (not shown) to receive data or information associated with transaction instruments 1019. Applications 1011 may receive data or information from incoming data received by the communication module.

As described above according to one or more embodiments, omni smart card 1002 may include processes that may be executed to allow user 1020 to select a transaction instrument captured and received from user device 1010 using an input device of omni smart card 1002, display the transactions instruments using an output display device of omni smart card 1002 having a display module, and select a transaction instrument for use in connection with a transaction.

In an embodiment where user 1020 wishes to transmit data or information associated with one or more transaction instruments 1019 from user device 1010 to omni smart card 1002, user 1020 may cause a communication module of user device 1010 to communicate the transaction instrument data or information to omni smart card 1002. The transaction instrument data or information may be transmitted to omni smart card 1002 directly, using short range wireless communications such as Bluetooth Low Energy, LTE Direct, radio frequency, infrared, Bluetooth, and near field communications. In other embodiments, the transaction instrument data or information may be communicated over network 1060 to omni smart card 1002.

User device 1010 may include other applications as may be desired in particular embodiments to provide features to user device 1020. For example, other applications may include security applications for implementing client-side security features, programmatic client applications for interfacing with appropriate application programming interfaces (APIs) over network 1060, or other types of applications. Other applications may also include email, texting, voice and IM applications that allow a user to send and receive emails, calls, texts, and other notifications through network 1060. In various embodiments, other applications may include financial applications, such as banking, online payments, money transfer, or other applications associated with remote server 1050 such s a payment provider server. Other applications may include browser applications enabling user device 1010 to access websites and/or receive information from one or more online sources. Additionally, other applications may include social networking/media application, including microblogging applications. Other applications may contain other software programs, executable by a processor, including a graphical user interface (GUI) configured to provide an interface to the user.

User device 1010 may further include a database which may include, for example, identifiers such as operating system registry entries, cookies associated with applications 1011 and/or other applications, identifiers associated with hardware of user device 1010, or other appropriate identifiers, such as identifiers used for payment/user/device authentication or identification. In one embodiment, identifiers in database may be used by an entity device or server and/or payment provider, such as remote server 1050, to associate user device 1020 with a particular account maintained by the payment/credit provider.

In various embodiments, the database may further include user information data to access user accounts, such as payment account information for a payment account with remote server 1050 such as a payment provider server. Such payment account information may be communicated to omni smart card 1002 for storage and use in connection with transactions. Thus, the database may include user personal information (e.g. a name, social security number, user financial information, or other identifying information), a user account identifier, and a user device identifier. In various embodiments, database may include online account access information. The database may also store monetary transfer information, including transaction histories of monetary transfers. The database may include transaction histories stored for later use.

In various embodiments, user device 1010, entity device or server 1005 and omni smart card 1002 include at least one communication module adapted to communicate with each other and/or remote server 1050 over network 1060 and/or directly. Thus, the respective communication modules may include a DSL (e.g., Digital Subscriber Line) modem, a PSTN (Public Switched Telephone Network) modem, an Ethernet device, a broadband device, a satellite device and/or various other types of direct wired and/or wireless network communication devices including microwave, radio frequency, infrared, Bluetooth, and near field communication components. The communication modules may communicate directly with another nearby device using short range communications, such as Bluetooth Low Energy, LTE Direct, radio frequency, infrared, Bluetooth, and near field communications. Thus, the communication modules may include various specialized short range communication modules that may connect with nearby devices.

Remote server 1050 may be maintained, for example, by an online payment service provider, which may provide payment service to a user. In this regard, remote server 1050 includes one or more processing applications, which may facilitate transactions via communication devices, such as user device 1010, omni smart card 1002 and entity device or server 1005. In one example, remote server 1050 may be provided by PAYPAL®, Inc. of San Jose, Calif., USA. However, in other embodiments remote server 1050 may be maintained by or include a merchant, financial services provider, and/or other service provider, which may provide transaction services to user 102. Remote server 1050 may additionally provide use of payment accounts for use in transferring monetary values.

Remote server 1050 of FIG. 10 includes a transaction processing application 1052, other applications 1054, a database 1056, and a network interface component 1058. Transaction processing application 1052 and other applications 1054 may correspond to processes, procedures, and/or applications executable by a hardware processor, for example, a software program. In other embodiments, remote server 1050 may include additional or different software as required.

Transaction processing application 1052 may execute one or more modules of remote server 1050 to receive and/or transmit information between user device 1010, omni smart card 1002 and entity device or server 1005 for processing and completion of transactions for user 1020 and one or more entities. In this regard, transaction processing application 1052 may be configured to receive and/or transmit information between user device 1010, omni smart card 1002 and entity device or server 1005 for processing and completion of transactions such as monetary or information transfers. For example, transaction processing application 1052 may include one or more applications to process a request for a transfer for a monetary amount from user 102 to an entity. Transaction processing application 1052 may receive a request for a transfer of a monetary amount from user 1020 and corresponding to user device 1010 or omni smart card 1002. The request may include transaction instrument information as well as user unique identification information such as biometric information. Transaction processing application 1052 may complete the request for the transfer of the monetary amount using the received information. The request may correspond to sending the monetary amount to entity device or server 1005; therefore transaction processing application 1052 may credit and post the monetary amount to a user account and/or financial account of entity device or server 1005. Transaction processing application 1052 may provide transaction histories, including receipts, for use by user device 1010 to complete or retain a history of the transfers.

In various embodiments, remote server 1050 includes other applications 1054 as may be desired in particular embodiments to provide features to remote server 1050. For example, other applications 1054 may include security applications for implementing server-side security features, programmatic server applications for interfacing with appropriate application programming interfaces (APIs) over network 1060, or other types of applications. Other applications 1054 may contain software programs, executable by a processor, including a graphical user interface (GUI), configured to provide an interface to a user.

Additionally, remote server 1050 includes database 1056. As previously discussed, user 1002 and en entity associated with entity device or server 1005 may establish one or more user accounts with remote server 1050. User accounts in database 1056 may include user information, such as name, address, payment/funding information, additional user financial information, and/or other desired user data. User 1020 may link user accounts to user device 1010 through a user device identifier. Thus, when a device identifier corresponding to user device 1010 is transmitted to remote server 1050, e.g. from user device 1010 or from omni smart card 1002, a user account belonging to user 102 may be found. Database 1056 may further store transaction information corresponding to user 102 and/or transaction history for completed transactions.

In various embodiments, transaction processing application 1052 or other applications 1054 may assign a one branded card to an omni smart card, and may uniquely tag each transaction instrument stored in the omni smart card with a special tag.

In various embodiments, remote server 1050 includes at least one communication module (NIC) 1058 adapted to communicate with network 1060 including user device 1010, omni smart card 1002 and entity device or server 1005. In various embodiments, network interface component 1058 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 1060 may be implemented as a single network or a combination of multiple networks. For example, in various embodiments, network 1060 may include the Internet or one or more intranets, landline networks, wireless networks, and/or other appropriate types of networks. Thus, network 1060 may correspond to small scale communication networks, such as a private or local area network, or a larger scale network, such as a wide area network or the Internet, accessible by the various components of system 1000.

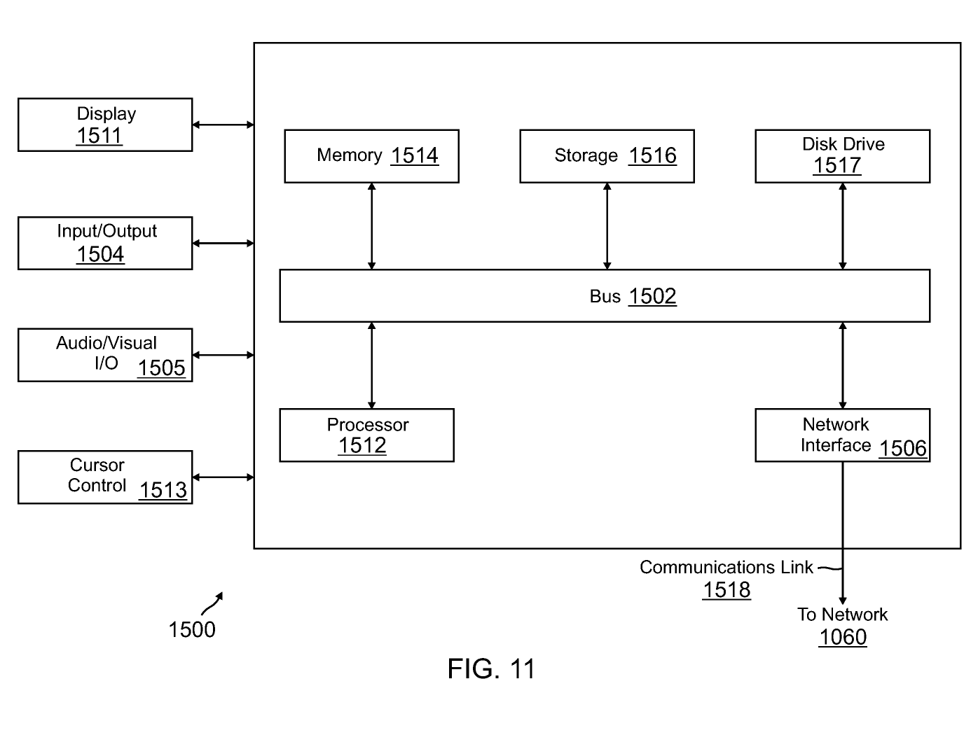

Referring now to FIG. 11 is a block diagram of a computer system suitable for implementing one or more components in FIG. 10, according to an embodiment of the present disclosure.

FIG. 11 is a block diagram of a computer system suitable for implementing one or more components in FIG. 10, according to an embodiment. In various embodiments, a user device, for example, user device 1010 may comprise a personal computing device (e.g., smart phone, a computing tablet, a personal computer, laptop, PDA, Bluetooth device, key FOB, badge, etc.) capable of communicating with the network. Omni smart card 1002 may comprise a device in the form of a transaction card (e.g., a credit card form), a Bluetooth device, a key FOB, a badge, etc. capable of communicating with the network or with near devices (e.g., via near communication protocols). The entity device or server and/or remote server may utilize a network computing device (e.g., a network server) capable of communicating with the network. It should be appreciated that each of the devices utilized by users, entities and service providers may be implemented as computer system 500 in a manner as follows.

Computer system 1500 includes a bus 1502 or other communication mechanism for communicating information data, signals, and information between various components of computer system 1500. Components include an input/output (I/O) component 1504 that processes a user action, such as selecting a user interface such as a toggle button, user unique identification information such as biometric information, keys from a keypad/keyboard, selecting one or more images, links, etc., and sends a corresponding signal to bus 1502. I/O component 1504 may also include an output component, such as a display 1511 and a cursor control 1513 (such as an interface, keyboard, keypad, mouse, etc.). An optional audio input/output component 1505 may also be included to allow a user to use voice for inputting information by converting audio signals. Audio I/O component 1505 may allow the user to hear audio. A transceiver or network interface 1506 transmits and receives signals between computer system 1500 and other devices, such as a user device, an entity device, or a remote server via network 1060. In one embodiment, the transmission is wireless, although other transmission mediums and methods may also be suitable. One or more processors 1512, which can be a micro-controller, digital signal processor (DSP), EMV or other processing component, processes these various signals, such as for display on computer system 1500 or transmission to other devices via a communication link 1518. Processor(s) 1512 may also control transmission of information, such as cookies or IP addresses, to other devices.

Components of computer system 1500 also include a system memory component 1514 (e.g., RAM), a static storage component 1516 (e.g., ROM), and/or a disk drive 1517. Computer system 1500 performs specific operations by processor(s) 1512 and other components by executing one or more sequences of instructions contained in system memory component 1514. Logic may be encoded in a computer readable medium, which may refer to any medium that participates in providing instructions to processor(s) 1512 for execution. Such a medium may take many forms, including but not limited to, non-volatile media, volatile media, and transmission media. In various embodiments, non-volatile media includes optical or magnetic disks, volatile media includes dynamic memory, such as system memory component 1514, and transmission media includes coaxial cables, copper wire, and fiber optics, including wires that comprise bus 1502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, magnetic strip, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 1500. In various other embodiments of the present disclosure, a plurality of computer systems 1500 coupled by communication link 1518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A smart device comprising:
an input device for receiving, from a user, user inputs including unique user authentication information;
an output device comprising a display module for displaying transaction instrument information associated with one or more transaction instruments;
a non-transitory memory storing the transaction instrument information associated with the one or more transaction instruments; and
at least one hardware processor in communication with the input device, the output device, and the non-transitory memory, the hardware processor(s) configured to:
present, on the output device, transaction instrument information associated with each of the one or more transaction instruments;
determine at least one user-selected transaction instrument based at least in part on the user inputs received via the input device;
encode one or more parameters associated with the at least one user-selected transaction instrument; and
provide transaction instrument information including the one or more parameters associated with the selected transaction instrument on the output device for use in connection with a transaction.

2. The smart device of claim 1, wherein the provided transaction instrument information associated with the selected transaction instrument is in turn provided to an entity at a POS in connection with the transaction.

3. The smart device of claim 1, further comprising a communications module for receiving communications including the transaction instrument information from a user device, wherein the user device captures the transaction instrument information via a user device interface.

4. The smart device of claim 3, wherein the communications received from the user device are encoded.

5. The smart device of claim 3, wherein the communication module receives the communications including the transaction instrument information from the user device via Bluetooth communications.

6. The smart device of claim 1, wherein the unique user authentication information further comprises biometric information of the user.

7. The smart device of claim 1, wherein the input device further comprises a button configured to receive the user inputs for selecting a desired transaction instrument.

8. The smart device of claim 1, wherein the hardware processor(s) is further configured to enable or disable use of a transaction instrument(s) based at least in part on one or more predetermined settings in connection with a specified use or a specified user.

9. The smart device of claim 8, wherein the predetermined settings further comprise restricting use of one or more transaction instrument(s) based on the specified user, wherein the specified user is not allowed to use a restricted transaction instrument(s) in connection with transactions.

10. The smart device of claim 8, wherein the predetermined settings further comprise restricting information about one or more selected transaction instrument(s) from being communicated in connection with transactions for the specified use.

11. The smart device of claim 1, wherein the transaction instrument information including the one or more parameters associated with each of the one or more transaction instruments further comprises at least one of a transaction instrument name, an account number, an expiration date, a code, or payment provider account information.

12. The smart device of claim 1 further comprising embossed data disposed on at least a portion of a side of the smart device, wherein the embossed data comprises transaction instrument information including a name of the transaction instrument.

13. The smart device of claim 1, wherein the transaction instrument information further comprises information about one or more funding sources including one or more credit cards, debit cards, gift cards, or other information including driver's license information, gym membership information, medical card information, or insurance information.

14. The smart device of claim 1, further comprising a programmable magnetic strip disposed on a side of the smart device, the programmable magnetic strip configured to work with a magnetic strip reader associated with an entity, wherein the processor(s) is further configured to control the programmable magnetic strip to allow encoding, in real time, of the one or more parameters associated with the at least one user-selected transaction instrument.

15. The smart device of claim 1, further comprising a programmable EMV chip, wherein the processor(s) is further configured to control the EMV chip to allow encoding, in real time, of the one or more parameters associated with the at least one user-selected transaction instrument.

16. The smart device of claim 1, further comprising charging contacts, induction coupling, or solar cells adapted to power the smart device.

17. The smart device of claim 1, wherein the processor(s) is further configured to: encode the stored transaction instrument information associated with the one or more transaction instruments.

18. The smart device of claim 1, wherein the processor(s) is further configured to: encode the transaction instrument information associated with each of the one or more transaction instruments based on a timing signal, wherein the transaction instrument information associated with the transaction instrument(s) is changed at least every 30 seconds, every 60 seconds or every 120 seconds.

19. A method comprising:
receiving, by an electronic processor of a smart card device, from a user, user inputs including unique user authentication information;
storing, by the electronic processor of the smart card device, transaction instrument information associated with one or more transaction instruments;
presenting, by the electronic processor of the smart card device, transaction instrument information associated with each of the one or more transaction instruments;
receiving, by the electronic processor of the smart card device, from the user, an input selecting a transaction instrument for use in connection with a transaction;
determining, by the electronic processor of the smart card device, the selected transaction instrument based at least in part on the user inputs;
encoding, by the electronic processor of the smart card device, the transaction instrument information associated with the transaction instrument selected by the user; and
providing the transaction instrument information associated with the selected transaction instrument for use in connection with the transaction.

20. The method of claim 18, further comprising setting up the smart card device, wherein the setting up further comprises:
receiving, by the electronic processor of the smart card device via a communication module, captured transaction instrument information associated with the one or more transaction instruments from a user device, wherein the user device captures the transaction information via a user device interface.

21. A non-transitory computer-readable medium comprising executable modules which, in response to execution by a computer system, cause the computer system to perform a method comprising:
receiving, from a user, user inputs including unique user authentication information;
storing transaction instrument information associated with one or more transaction instruments;
presenting transaction instrument information associated with each of the one or more transaction instruments;
receiving, from the user, an input selecting a transaction instrument for use in connection with a transaction;
determining the selected transaction instrument based at least in part on the user inputs;
encoding the transaction instrument information associated with the transaction instrument selected by the user; and
providing the transaction instrument information associated with the selected transaction instrument for use in connection with the transaction.
